(19) United States
(12) Patent Application Publication
(10) Pub. No.: US 2009/0218825 A1
(43) Pub. Date: Sep. 3, 2009

(54) Latch device for a card insertion module of a case

(76) Inventors: Li-Fu Chiang, Yonghe City (TW); Yu-Hsu Sun, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,933

(22) Filed: Feb. 28, 2008

(51) Int. Cl. E05C 1/08

(52) U.S. Cl. 292/140

(57) ABSTRACT

A latch device for a card insertion module of a case comprising a bracket, a motion rod, a latch assembly, and an elastic member. The bracket has a passage and a receiving groove. The motion rod passes through the passage and includes a restricting structure. The latch assembly can be received by rotation fashion in the receiving groove via the movement of the motion rod. The elastic member is received in the passage, and has a restricting piece. The bracket has holding grooves and the elastic member has holding structures. The elastic member can be stably mounted on the bracket to limit the motion rod in the passage via the engagement of the holding grooves and the holding structures. When the motion rod moves relatively to the elastic member, the restricting structure moves and is limited relatively to the restricting piece and the elastic member is kept on the bracket.

### BACKGROUND OF THE INVENTION

1. Field of the Invention

The present invention relates to a card insertion module assembly, especially to a latch device for a card insertion module of a case which is used in an industrial computer to conveniently fix and start a panel of the industrial case for easy assembly and low manufacturing costs.

2. Description of Related Art

With the development of data processing technology, computers are generally used in offices or factories for processing and storing large amounts of data. In computers, circuit boards are generally assembled in cases, and frame boards of the cases are fixed on the cases via bolts, screws and so on. Alternatively, side boards of the cases are fixed on the cases via fasteners. However, since products are thinner and thinner, smaller and smaller, the design of the products is more difficult. The bolt fixing methods have the shortcomings as follows:

In space aspects, because of continuing miniaturization of products, space, in cases must be reduced, so the difficulty and blind spots of design come out. In assembly aspects, bolts and screws must be detached or assembled one by one with tools, so the assembly operation is complicated. In cost aspects, a large quantity of screws are needed, so the assembly of the cases is more difficult and the costs are high. So the conventional bolt fixing methods are inconvenient for use in space aspects, assembly aspects or cost aspects.

Hence, there exist much inconvenience and shortcomings in the above conventional fixing methods. The inventors of the present invention believe that the shortcomings described above are able to be improved and finally suggest the present invention which is of a reasonable design and is an effective improvement.

### SUMMARY OF THE INVENTION

An object of the present invention is to provide a latch device for a card insertion module of a case for conveniently fixing a panel of an industrial computer. The present invention forms a plurality of holding grooves on a bracket and a plurality of holding structures corresponding to the holding grooves on an elastic member. Basing on the engagement of the hold grooves and the holding structures, the elastic member is fixed on the bracket to limit a motion rod in a passage, so that the motion rod can move relatively to the elastic member and a restricting structure can move and be limited relatively to a restricting piece, whereby the present invention can unlatch or latch the panel of the industrial case and start a power supply.

Another object of the present invention is to reduce the difficulty of assembly and reduce manufacturing costs, and keep the elastic member on the bracket and prevent the elastic member from sliding down or falling off even if the motion rod moves frequently, via the engagement of the holding grooves of the bracket and the holding structures of the elastic member.

To achieving the above-mentioned objects, a latch device for a card insertion module of a case in accordance with the present invention is provided. The latch device for a card insertion module of a case includes a bracket, a motion rod, a latch assembly and an elastic member. The bracket has a passage and a receiving groove corresponding to the passage. The motion rod passes through the passage of the bracket and includes a restricting structure. The latch assembly is pivotedly mounted on the bracket and located in the passage, and the latch assembly may be pushed to be rotatably received in or separated from the receiving groove via the movement of the motion rod. The elastic member is mounted on the bracket and correspondingly received in the passage for limiting the motion rod to moving in the passage. The elastic member has a restricting piece corresponding to the restricting structure. The bracket has a plurality of holding grooves and the elastic member has a plurality of holding structures corresponding to the plurality of holding grooves, and the elastic member may be stably mounted on the bracket to limit the motion rod in the passage via the engagement of the holding grooves and the holding structures.

Accordingly, when the motion rod moves relatively to the elastic member, the restricting structure may move and be limited relatively to the restricting piece, so that the latch assembly rotates relatively to the receiving groove. Basing on the engagement of the holding grooves and the holding structures, the present invention can simplify the assembly and reduce manufacturing costs, and keep the elastic member on the bracket and prevent the elastic member from sliding down or falling off even if the motion rod moves frequently.

To further understand technical contents and efficacy of the present invention, please refer to the following detailed description and drawings related the present invention. It is believed that the objects, features and advantages of the present invention will be understood deeply. However, the drawings are only to be used as references and explanations, not to limit the present invention.

### BRIEF DESCRIPTION OF THE DRAWINGS

FIG. 1 is an exploded perspective view of a latch device for a card insertion module of a case according to the present invention;

FIG. 2 is an exploded perspective view of the latch device for a card insertion module of a case according to the present invention, from another angle;

FIG. 3 is an assembled perspective view of the latch device for a card insertion module of a case according to the present invention;

FIG. 4 is an assembled perspective view of the latch device for a card insertion module of a case according to the present invention, from another angle;

FIG. 5 is a planar schematic view of the assembled latch device for a card insertion module of a case according to the present invention;

FIG. 6 is a perspective view of the assembled latch device for a card insertion module of a case according to the present invention, in an unlatch state;

FIG. 7 is a perspective view of the assembled latch device for a card insertion module of a case according to the present invention, in a latch state; and

FIG. 8 is a perspective view of the assembled latch device for a card insertion module of a case according to the present invention, in a power-on state.

### DETAILED DESCRIPTION OF THE PREFERRED EMBODIMENTS

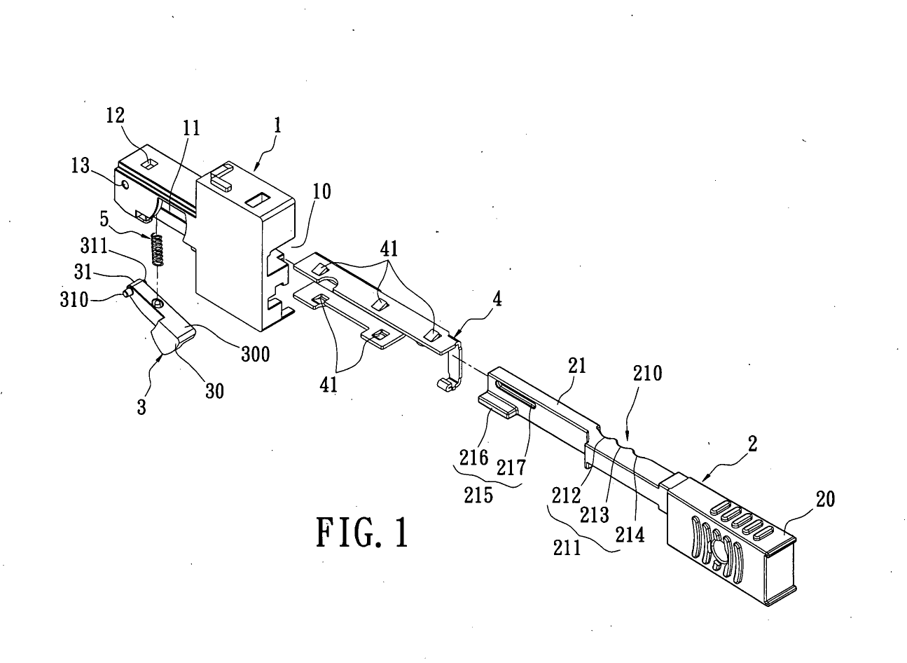

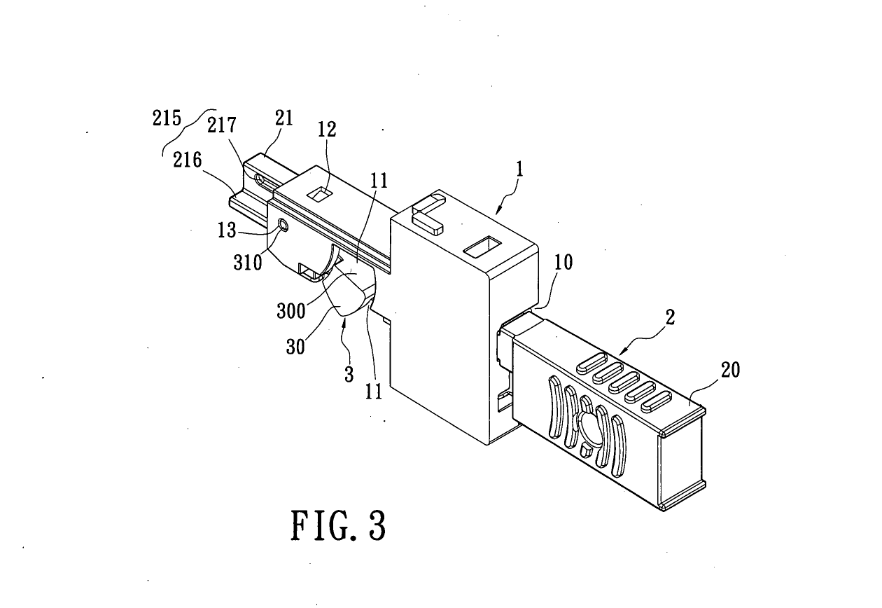

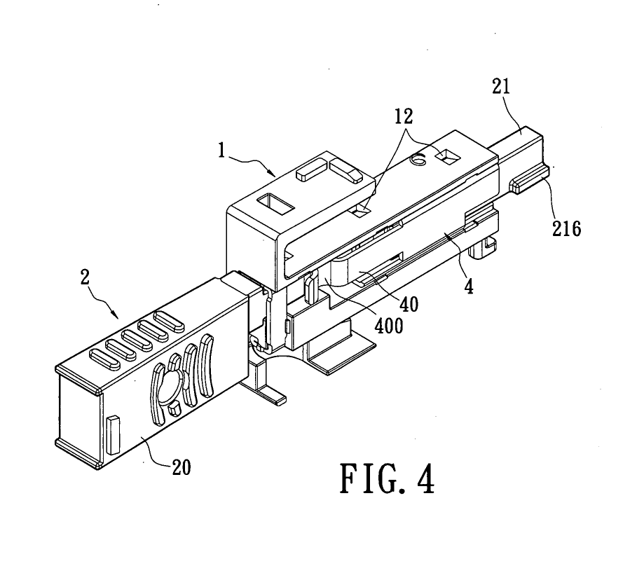

Please refer to FIGS. 1-5 illustrating an embodiment of a latch device for a card insertion module of a case according to the present invention. The present invention is assembled on a fixed plate seat (not shown) on a back side of an industrial case for unlatching or latching a panel of the industrial case and starting a power supply. The latch device for a card insertion module of a case includes a bracket 1, a motion rod 2, a latch assembly 3 and an elastic member 4.

The bracket 1, which is made of a metal material, has a passage 10, a receiving groove 11 corresponding to the passage 10, a plurality of holding grooves 12 corresponding to the passage 10 and a pivot hole 13 corresponding to the passage 10, which are formed in the bracket 1. The passage 10 is narrow and long for receiving the motion rod 2. The receiving groove 11 extending through the bracket 1 is arc-shaped for receiving the latch assembly 3. The holding grooves 12 are used for fixing the elastic member 4. The latch assembly 3 may be pivotedly connected with the pivot hole 13.

The motion rod 2, which is made of a medal material, is shaped like a rectangular strip. The motion rod 2 correspondingly passes through the passage 10 of the bracket 1 and may reciprocatingly move a distance in the passage 10. The motion rod 2 includes a handle portion 20 and a motion rod portion 21. Users can easily hold the handle portion 20 in order to push and pull the motion rod 2 effectively. The motion rod portion 21 is movably received in the passage 10 and includes a restricting structure 210 and a pushing structure 215. The curved restricting structure 210 is formed on the front end of the motion rod portion 21 and has a raising arc-shaped surface 211 formed on a surface thereof, which has a first raising segment 212, a second raising segment 213 and a third raising segment 214. The three raising segments 212, 213, 214 are arranged at intervals to form a multi-segment. restricting structure. The pushing structure 215 is formed on the back end of the motion rod portion 21 and includes a pushing member 216 and an opening slot 217. The pushing member 216 is shaped like a long strip for colliding with a power switch (not shown) for the panel and pushing the latch assembly 3. The opening slot 217 is narrow and long for engaging with the latch assembly 3 to drive the latch assembly 3. Accordingly, under the action of the pushing structure 215, the latch assembly 3 can be driven to be rotatably received in or separated from the receiving groove 11.

The latch assembly 3, which is made of a metal material, is pivotedly mounted on the bracket 1 and located in the passage 10. The latch assembly 3 can be driven to rotate to be separated from or received in the receiving groove 11 via the movement of the motion rod portion 21 of the motion rod 2 in the passage 10. The latch assembly 3 includes a latch portion 30 and a pivoted portion 31. The latch portion 30 has an arc-shaped hamulus structure, corresponding to the shape of the receiving groove 11, to be received in the receiving groove 11. Two rotating pivot shafts 310, 311 are respectively formed on two side surfaces of the pivoted portion 31, wherein the rotating pivot shaft 310 pivotedly engages with the pivot hole 13 of the bracket 1 and the other rotating pivot shaft 311 is movably disposed in the opening slot 217 of the pushing structure 215, so that the latch portion 30 of the latch assembly 3 can rotate about the two rotating pivot shafts 310, 311.

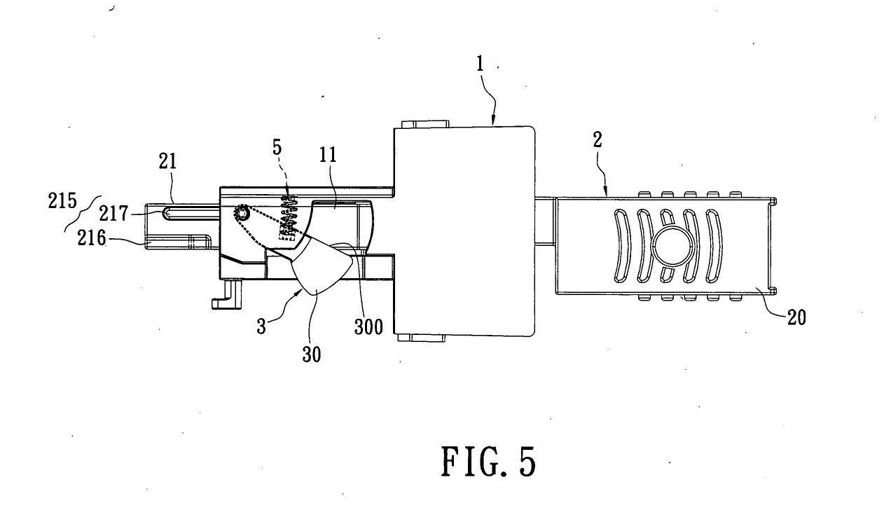

Furthermore, the latch assembly 3 also has a motion surface 300 which is an inclined plane formed on one side of the latch portion 30. An elastic assembly 5 is disposed between the motion surface 300 and the passage 10 of the bracket 1. Since the motion surface 300 is an inclined plane, the elastic assembly 5 can be inclinedly disposed on the motion surface 300 (as shown in FIG. 5). Basing on elasticity of the elastic assembly 5, the latch assembly 3 can be driven to be effectively received in or separated from the receiving groove 11 via the movement of the motion rod 2 and the rotation of the rotating pivot shaft 310, 311 during rotation, so it is avoided that dead spots arise between the elastic assembly 5 and the latch assembly 3, which causes that the latch assembly 3 cannot rotate and be latched successfully.

The elastic member 4 is mounted on the bracket 1 and correspondingly received in the passage 10 to limit the relative movement of the motion rod portion 21 of the motion rod 2 in the passage 10. The elastic member 4 has a restricting piece 40 and a plurality of holding portions 41. The restricting piece 40 corresponds to the restricting structure 210 of the motion rod portion 21 and has a raising portion 400 corresponding to the raising arc-shaped surface 211 of the restricting structure 210, which may be relatively limited on the first, the second and the third raising segments 212, 213, 214.

Accordingly, when the motion rod portion 21 of the motion rod 2 moves relatively to the elastic member 4, the first, the second and the third raising segments 212, 213, 214 of the raising arc-shaped surface 211 of the restricting structure 210 move relatively to the raising portion 400 of the restricting piece 40. The first, the second and the third raising segments 212, 213, 214 are selectively limited on the raising portion 400, so that the motion rod portion 21 is limited in one position of an unlatch position, a latch position and a power supply position to unlatch or latch the panel in the industrial case, start the power supply and so on.

In the present invention, the plurality of holding portions 41 engage with the plurality of holding grooves 12 correspondingly so that the elastic member 4 is mounted on the bracket 1 and received in the passage 10 effectively and stably and the motion rod portion 21 of the motion rod 2 is effectively limited in the passage 10 to form a predetermined position (such as the unlatch position, the latch position or the power supply position).

Thus, besides unlatching, latching the panel of the industrial case and starting a power supply effectively, the present invention further can reduce the difficulty of assembly, reduce manufacturing costs, keep the elastic member 4 on the bracket 1 even if the motion rod 2 moves frequently, and greatly reduce the possibility of the elastic member 4 sliding down or falling off. When the motion rod-2 moves relatively to the elastic member 4, the restricting structure 210 can move and is limited relatively to the restricting piece 40 thereby the present invention can unlatch or latch the panel of the industrial case and start the power supply.

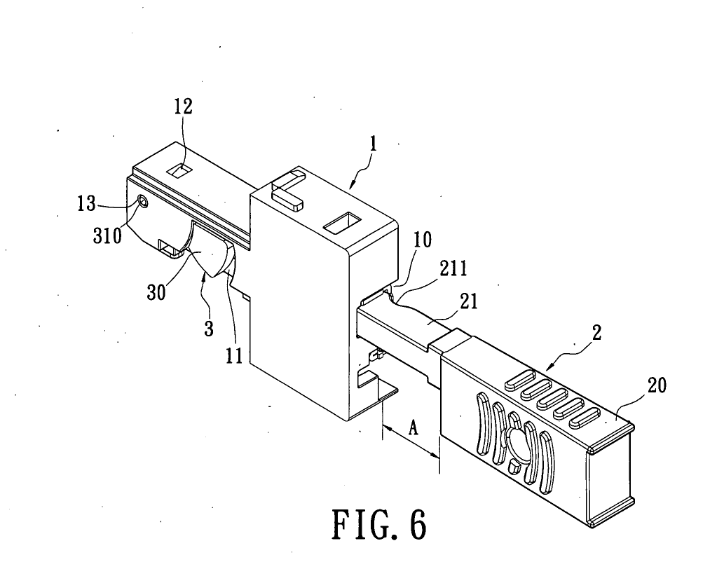

Please refer to FIGS. 6-8 illustrating the assembled latch device for a card insertion module of a case of the present invention in an unlatch state, a latch state and a power-on state. As shown in FIG. 6, when the motion rod portion 21 of the motion rod 2 moves an unlatch distance A relatively to the bracket 1, the motion rod 2 is limited in the unlatch position via the engagement of the restricting piece 40 and the restricting structure 210. With the movement of the pushing member 216 of the pushing structure 215 (as shown in FIG. 1), the elastic assembly 5 is compressed (as shown in FIG. 5) and the latch assembly 3 is indirectly pushed to rotate into the receiving groove 11, whereby the latch assembly 3 is in the unlatch state.

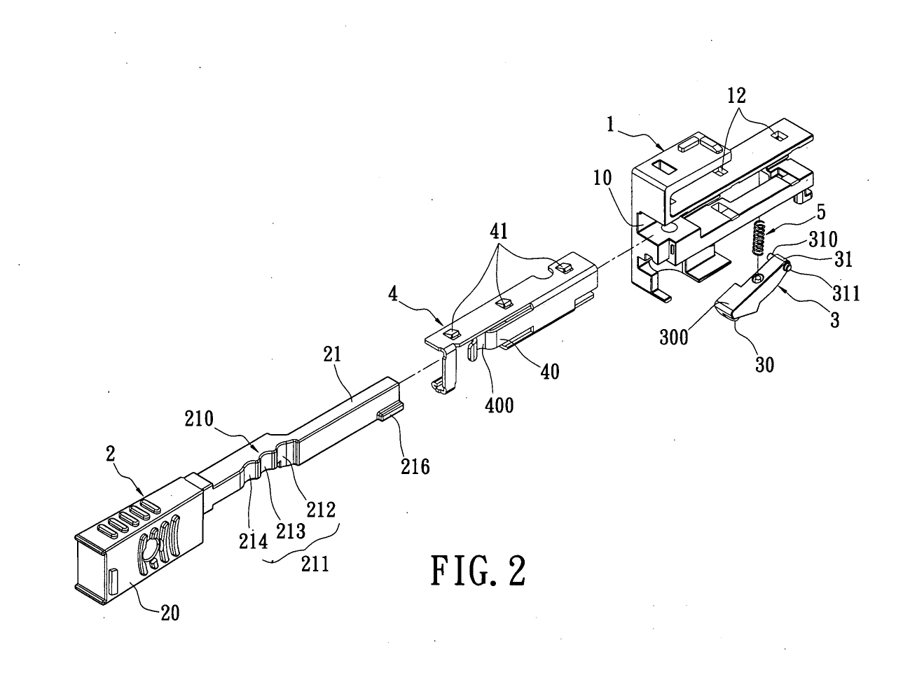

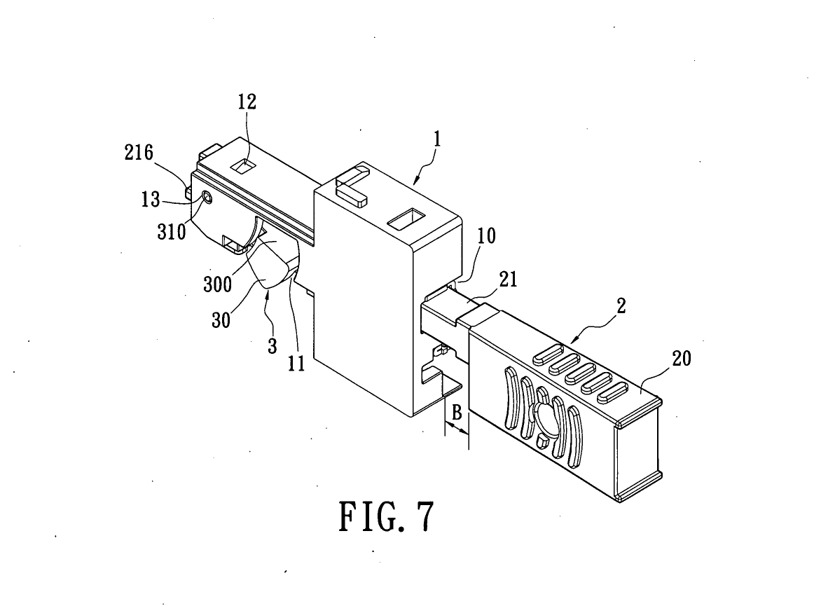

As shown in FIG. 7, when the motion rod portion 21 of the motion rod 2 moves a latch distance B relatively to the bracket 1, the motion rod 2 is limited in the latch position via the engagement of the restricting piece 40 and the restricting structure 210 (as shown in FIG. 2). Under the action of the restoring force of the elastic assembly 5 (as shown in FIG. 5), the latch assembly 3 is detached from the receiving groove 11. So the latch assembly 3 is in the latch state.

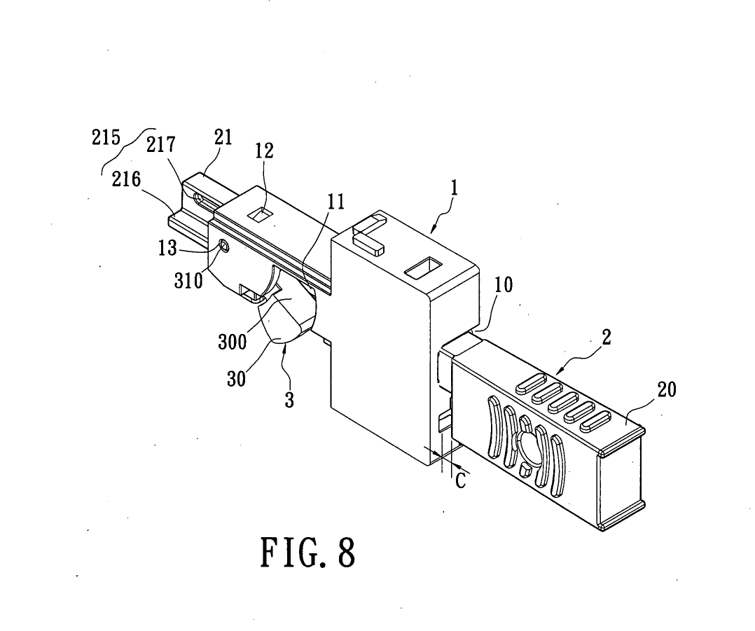

As shown in FIG. 8, when the motion rod portion 21 of the motion rod 2 moves a power supply distance C relatively to the bracket 1, the motion rod 2 is limited in the power supply position via the engagement of the restricting piece 40 and the restricting structure 210 (as shown in FIG. 2). The pushing member 216 (as shown in FIG. 5) of the pushing structure 215 of the motion rod portion 21 collides with the switch on the panel of the industrial case so that the panel is in the power-on state.

Consequently, the features of the present invention are as follows:

(1) Basing on the engagement of the holding grooves and the holding structures, the elastic member is stably mounted on the bracket to ensure that the motion rod is limited in particular positions in the passage and moves relatively to the elastic member, thereby unlatching or latching the panel and controlling the state of the power supply.

(2) The present invention can unlatch or latch the panel of the industrial case and start the power supply effectively to reduce the difficulty of assembly and reduce manufacturing costs.

(3) Whether the motion rod moves frequently or not, the elastic member can be kept on the bracket, thereby greatly reducing the possibility of sliding down or falling off.

(4) The motion surface of the latch assembly is an inclined plane, so the latch assembly can be effectively received in or separated from the receiving groove during rotation under the influence of the elasticity of the elastic assembly, thereby avoiding that dead spots arise between the elastic assembly and the latch assembly.

What are disclosed above are only the specification and the drawings of one of preferred embodiments of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A latch device for a card insertion module of a case, comprising:
a bracket, having a passage and a receiving groove corresponding to the passage;
a motion rod, passing through the passage of the bracket and including a restricting structure;
a latch assembly, mounted by pivot on the bracket and located in the passage, which is pushed to be received in by rotation fashion or separated from the receiving groove via the movement of the motion rod; and
an elastic member, mounted on the bracket and correspondingly received in the passage to limit the motion rod's movement in the passage, and the elastic member having a restricting piece corresponding to the restricting structure;
wherein the bracket has a plurality of holding grooves and the elastic member has a plurality of holding structures corresponding to the plurality of holding grooves, the elastic member stably mounted on the bracket and received in the passage to limit the motion rod in the passage via the engagement of the plurality of holding grooves and the plurality of holding structures;
wherein the motion rod moves relative to the elastic member, the restricting structure moves relative to the restricting piece and the restricting structure movement is thus limited by the restricting piece, and the latch assembly rotates relatively to the receiving groove.

2. The latch device as claimed in claim 1, wherein the motion rod has a pushing structure which drives the latch assembly to rotate into the receiving groove.

3. The latch device as claimed in claim 1, wherein the latch assembly has two rotating pivot shafts disposed on the bracket and the motion rod respectively.

4. The latch device as claimed in claim 1, wherein the latch assembly has a motion surface, and an elastic assembly is placed on an incline angle between the bracket and the motion surface to drive the latch assembly to separate from the receiving groove.

5. The latch device as claimed in claim 4, wherein the motion surface is an inclined plane and the elastic assembly is placed on an incline angle on the motion surface.

6. The latch device as claimed in claim 1, wherein the restricting structure of the motion rod forms a raising arc-shaped surface which has a plurality of raising segments, and the restricting piece of the elastic member forms a raising portion corresponding to the raising arc-shaped surface.

7. The latch device as claimed in claim 6, wherein the raising portion is limited on the raising arc-shaped surface, the plurality of raising segments move relative to the raising portion and are selectively limited on the raising portion.
